(19) United States
(12) Patent Application Publication
(10) Pub. No.: US 2011/0069741 A1
(43) Pub. Date: Mar. 24, 2011

(54) SYSTEM AND METHOD FOR SEISMOLOGICAL SOUNDING

(76) Inventor: Alan Erickson, Bozeman, MT (US)

(21) Appl. No.: 12/566,132

(22) Filed: Sep. 24, 2009

(51) Int. Cl. H04B 1/00; G01V 1/28; H04B 1/707

(52) U.S. Cl. 375/141; 367/38; 375/147; 375/E01.002

(57) ABSTRACT

Systems and methods for seismological sounding with acoustic signals and, more particularly, systems and methods for performing geophysical surveys using spread spectrum acoustic waves generated by non-impulsive sources. A spread spectrum signal is generated and coupled to a medium that is to be sounded for propagation of an acoustic wave through the medium. One or more return signals are received from the medium that are generated by interaction between the acoustic wave and the medium. The return signals are possessed to obtain seismic sounding data describing the structural features of the medium.

### BACKGROUND OF THE INVENTION

1. Field of the Invention

The present invention relates to systems and methods for seismological sounding with acoustic signals. More particularly, aspects of the present invention relate to systems and methods for performing geophysical surveys using spread spectrum acoustic waves generated by non-impulsive sources.

2. Description of the Background

The conventional practice of reflection seismology makes use of an energy impulse to inject acoustic waves into the earth. Common methods of creating this impulse include explosions, air guns, dropped weights, and vibrating plates. The seismic waves resulting from these impulse sources then propagate through the earth, undergoing reflection and refraction due to discontinuities or gradations in density in the earth. Such discontinuities delineate boundaries between features such as water tables, rock layers, caves, faults, or man-made structures such as tunnels. A signal composed of the sum of the reflected waves reaches the surface of the earth and is measured by sensors. The standard practice is to calculate the time-domain signal amplitudes from all sensors, and to further process the data if and as required.

The standard practice has a number of inherent challenges and drawbacks. First, impulse stimulation sources require large energy inputs in order to overcome signal attenuation within the earth. This attenuation may be caused by several sources, e.g., scattering caused by inhomogeneous earth layers, the impedance of the earth, the natural low-pass filtering of the medium through which the impulse stimulation passes, etc. Generating the necessary large energy pulses can be expensive and invasive, requiring large equipment that is not convenient to transport to a sounding location without specialized vehicles. This limitation can make sounding with impulse stimulation sources particularly difficult in remote or difficult to access locations.

Second, the detected impulse signals are not easily distinguishable from sources of interference, such as amplifier noise, road traffic, mining, or natural seismic events. This limits the ability to perform accurate soundings in areas of high ambient seismic noise.

Third, most impulse sources contain consumable elements (e.g., explosives) and are therefore not suitable for permanent or semi-permanent emplacement (e.g. to continuously monitor for tunneling activity across a border or into a secure site). Those impulse sources that contain few or no consumable resources (e.g., sources utilizing gas compressed on-site) in general produce impulses with much lower energy densities. As a result, they suffer significantly from the attenuation and interference effects described above,

Fourth, impulse sources provide very little control over the parameters of the emitted signal, such as spectral distribution. Particular frequencies or frequency bands may be differentially absorbed or reflected by various features of the medium under study. In some cases, it would be desirable to either focus the energy of the signals in these frequencies or frequency bands or distribute the energy of the signals to avoid these frequencies or frequency bands. For example, resolving specific features, identifying soil types, penetrating groundwater, etc. can be dependent on spectral distribution of the signal and the received acoustic data. Using impulse based signal sources, such selectivity is generally unavailable.

Fifth, sounding methods using impulse sources are easy for third parties to detect and thus are relatively ineffective for surreptitious applications. For example, impulse sources would be inadequate to monitor for tunnel construction across a border or into a secure area without notifying the builders or users of the tunnel to the monitoring. Relatedly, because of their sensitivity to interference, impulse based soundings may be subject to jamming efforts (e.g., tunnel users may thwart detection of the tunnel by creating additional seismic noise in the area).

Sixth, in many circumstances, impulse sources are too intrusive or destructive. For example, impulse sources may be a nuisance or hazard in heavily populated or crowded areas, urban environments, wildlife refuges, cave systems and other protected spaces, potentially fragile environments such as unstable mineshafts, etc. Furthermore, impulse sources are typically too obtrusive to be run continuously for monitoring secure locations such as power plants, military sites, bank vaults, etc.

Seventh, it is generally not possible to distinguish between separate impulses. Thus, multiple simultaneous impulses appear as interference. Requiring impulses to be generated and received separately can greatly extend the amount of time required for a survey.

It is therefore an object of the present invention to provide an improved system and method for seismological sounding that overcomes the aforementioned challenges and drawbacks.

### BRIEF SUMMARY OF THE INVENTION

In some aspects, the present invention provides a system and method for seismological sounding by generating a continuous spread spectrum signal; coupling the signal to a medium that is to be sounded for propagation of an acoustic wave through the medium; receiving one or more return signals from the medium generated by interaction between the acoustic wave and the medium, i.e. the structural features thereof; and processing the return signals to obtain seismic sounding data describing the structural features of the medium. The method and apparatus are applicable to both scientific research and to commercial application. By way of example only, this could include petroleum and mineral surveys, civil surveys, detection of tunnels, shafts and caverns, and subsurface imaging techniques.

The present invention makes use of spread-spectrum linear modulation of a transmitter in place of a mechanism that generates impulses, thus moving some of the burden of increasing signal-to-noise ratio (SNR) from the power of the transmitter to signal processing in the receiver, allowing much lower energy densities to be utilized. This allows one to use substantially less powerful energy sources that are less cumbersome to transport, require less consumable elements, are less detectable by third parties, and are less intrusive than the conventionally used explosives or very large machinery, all while being more robust against interference or jamming.

Further, in some aspects, the present invention provides a system and method for seismological sounding that enables control over many of the signal parameters, such as the spectral distribution of energy. This permits more detailed data collection. Further, interference from ambient seismic noise may be reduced by selecting appropriate spectral distributions of the sounding signal.

In some aspects of the present invention, the transmitted spread spectrum signal can extend in time for as long as deemed necessary; the longer the transmitted sequence, the more total energy is transmitted into the earth or medium, and the more total energy is returned to the receiver. Aspects of the present invention therefore allow for the transmission of a smaller amount of energy per unit of time, while allowing an equivalent amount of total energy to be applied to features of interest. Advantageously, this allows soundings to be performed in protected spaces, potentially fragile environments, and areas where soundings are run continuously but must remain unobtrusive. One may perform soundings according to aspects of the invention through human-built infrastructure (e.g. building foundations, bridges, roads, etc.) without damage. Provision for soundings (e.g. transmit and receive attachment points) may be built into the structure of secure sites, border crossings, etc. Longer sequences also result in a reduction of the amplitude of some kinds of interference, thus allowing weaker signals of interest to be detected.

According to an aspect of the invention, a method is provided for performing seismological sounding. The method may include steps of: generating a continuous spread spectrum signal; generating in a target medium an acoustic wave corresponding to the spread spectrum signal; receiving one or more return signals from the target medium generated by interaction between said acoustic wave and the target medium; and processing the return signals to obtain seismic sounding data describing the target medium.

According to an aspect of the invention, a system is provided for effecting seismological sounding in a medium. The system may include a spreading sequence generator, a transmit transducer, a receive transducer, and a signal processor. The spreading sequence generator may be configured to generate a continuous spread spectrum signal. The transmit transducer may be configured to receive the continuous spread spectrum signal, mechanically couple the continuous spread spectrum signal to a target medium, and generate in the target medium an acoustic wave corresponding to the spread spectrum signal. The receive transducer may be configured to receive one or more acoustic return signals from the target medium generated by interaction between said acoustic wave and the target medium and convert the acoustic return signals to electronic return signals. The signal processor may be configured to receive the electronic return signals and process the electronic return signals to obtain seismic sounding data describing the medium

According to an aspect of the invention, a computer program product is provided for seismological sounding. The computer program product may include digital storage media and a set of machine readable instructions stored on said digital storage media. The machine readable instructions may include instructions executable by a computer to: generate a continuous spread spectrum signal; transmit the continuous spread spectrum signal to a transmit transducer mechanically coupled to a target medium; receive one or more return signals from a receive transducer mechanically coupled to a target medium; and process the return signals to obtain seismic sounding data describing the target medium.

The above and other aspects and features of the present invention, as well as the structure and application of various embodiments of the present invention, are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

A more complete appreciation of the invention and the attendant advantages thereof will be readily obtained as the same becomes better understood by reference to the following detailed description when considered with the accompanying drawings wherein:

FIG. 1 is a functional block diagram of a system for performing seismic sounding using a spread spectrum signal according to aspects of the present invention.

FIG. 2 is a functional block diagram of a system for performing seismic sounding using a spread spectrum signal according to aspects of the present invention.

FIG. 3 is a functional block diagram of a system for performing seismic sounding using a spread spectrum signal according to aspects of the present invention.

FIG. 4A is a flow chart illustrating a process for performing seismic sounding using a spread spectrum signal according to aspects of the invention.

FIG. 4B is a flow chart illustrating a process for performing seismic sounding using a spread spectrum signal according to aspects of the invention.

FIG. 5 is a functional block diagram of a system for performing seismic sounding using a spread spectrum signal according to aspects of the present invention.

FIG. 6 is a functional block diagram of a system for performing seismic sounding using a spread spectrum signal according to aspects of the present invention.

FIG. 7 is a functional block diagram of a system for performing seismic sounding using a spread spectrum signal according to aspects of the present invention.

FIG. 8 is a functional block diagram of a system for performing seismic sounding using a spread spectrum signal according to aspects of the present invention.

FIG. 9 is an illustrative output of seismic data generated by a system for performing seismic sounding using a spread spectrum signal according to an embodiment of the present invention.

### DETAILED DESCRIPTION OF THE PREFERRED EMBODIMENTS

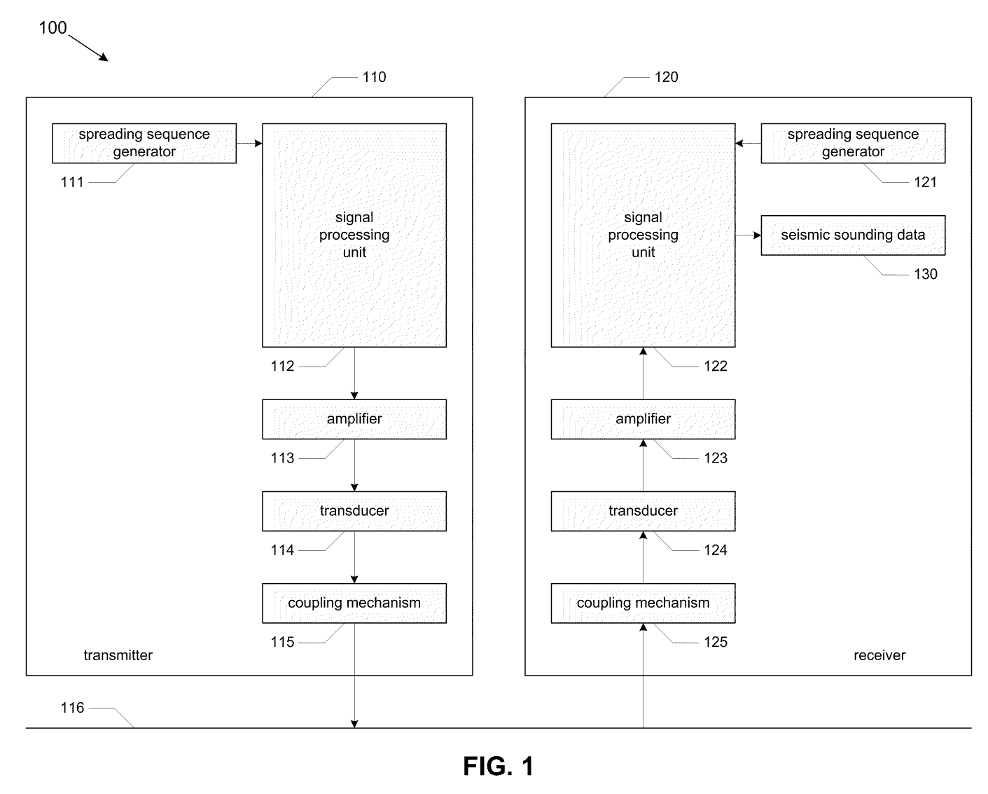

FIG. 1 illustrates a system 100 for performing seismic sounding using a spread spectrum signal according to some aspects of the invention. As illustrated in FIG. 1, the system 100 may include a transmitter 110 and a receiver 120. The transmitter 110 may include a spreading sequence generator 111, a signal processing unit 112 for generating a spread spectrum signal based upon the spreading sequence, an amplifier 113 for increasing the power of the spread spectrum signal, a transducer 114 for converting the spread spectrum signal to mechanical motion, and a coupling mechanism 115 for coupling the mechanical motion to the target medium 116 (e.g., the ground).

In some aspects of the invention, the spreading sequence generator 111 may generate a pseudorandom noise (PRN) sequence, which can be implemented as a pseudorandom sequence of binary digits. In some embodiments, the spreading sequence generator 111 may be an application specific integrated circuit (“ASIC”), field-programmable gate array (“FPGA”), a digital signal processor (“DSP”), an assembly of discrete logical elements (e.g., NAND gates, XOR gates, etc.), or a general purpose microprocessor configured to execute software instructions stored in a computer readable memory. Pursuant to one embodiment of the invention, a commercially available personal computer (e.g., a Dell Latitude D620) programmed with software (e.g., commercially available software such as MathWorks™ MATLAB®, Parametric Technology Corporation (“PTC®”) Mathcad®, etc.) to generate a suitable PRN sequence may be used to generate the spreading sequence.

In some preferred embodiments, the PRN may be chosen to have several properties, which can be summarized as: (a) its autocorrelation is very low, i.e., no part of the PRN signal closely resembles any other part; (b) its bandwidth is high compared to that of a data signal; and (c) if other signals are to be used within the same receiver range, the cross correlation between the PRN sequences must be low to prevent interference. Pursuant to one embodiment of the present invention, a software-based XOR-feedback shift register may be used to provide maximum-length sequences, e.g., of length on the order of 10¹² bits. Other sequence types could include Kasami codes, Gold codes, chaotic sequences generated by means known to those of skill in the art, and natural noise such as that from thermal sources. In some embodiments, Gold codes may be expedient for multiple-station concurrent studies due to their low and well specified cross correlation and ease of generation. Pursuant to a further embodiment, the spreading signal may be a recorded signal, seismic or otherwise, from natural or man-made sources, including thermal shot noise, atmospheric, tectonic, ambient seismic, traffic, mining, excavating, drilling, littoral, river, or animal noise.

The signal processing unit 112 may be configured to receive a PRN binary sequence and generate a continuous spread spectrum signal based upon the PRN sequence. In some embodiments, the signal processing unit 112 may be an ASIC, an FPGA, a DSP, an assembly of discrete logical elements, or a general purpose microprocessor configured to execute software instructions stored in a computer readable memory. Pursuant to one embodiment of the invention, a commercially available personal computer (e.g., a Dell Latitude D620) programmed with conventional signal processing software (e.g., commercially available software such as MathWorks™ MATLAB®, PTC® Mathcad®, etc.) may be used to generate the spreading sequence.

In one embodiment of the present invention, the signal processing unit 112 may be configured to perform direct-sequence spread-spectrum modulation (DSSS). In DSSS, a carrier frequency may be modulated by both a data signal and a pseudorandom noise (PRN) or other bandwidth-spreading signal. As used herein, modulation may comprise any form of modulation that is suitable for transmission through the target medium 116 (e.g., amplitude modulation, frequency modulation, phase modulation, etc.) The use of DSSS and related signals provides geologic sounding that is less detectable by third parties (e.g., eavesdroppers, those engaged in illicit activity, etc.) and also less susceptible to jamming.

In some implementations of the present invention, both the DSSS carrier signal and the DSSS data signal can be treated as having zero frequency, and are modulated by the pseudorandom noise sequence. Thus, the output waveform is based only on the PRN sequence. This waveform may be filtered as desired; for example, it can be bandpass-filtered to match the capabilities of transmitter and receiver. In some embodiments where the target medium 116 is, for example, the ground, the continuous spread spectrum signal may be filtered to have a bandwidth range between at least 0.1 Hz to 1,000 Hz.

The amplifier 113 may be configured to receive an input signal (e.g., from the signal processing unit 112) and output a corresponding amplified signal sufficient to drive the transducer 114. Pursuant to one embodiment of the invention, a commercial amplifier (e.g., an AudioSource Amp5.3, a commercially available amplifier capable of delivering 250 W into 4Ω over a range of 20 Hz to 20 kHz) may be used. In other embodiments, other amplifiers having sufficient bandwidth characteristics and electrical properties suitable to drive the transducer according to the continuous spread spectrum signal may be used. In some embodiments where the target medium 116 is, for example, the ground, amplifiers having bandwidth range between at least 0.1 Hz to 1,000 Hz may be used.

The transducer 114 can be any device that converts the spread spectrum signal to mechanical motion. In some embodiments, the transducer 114 may use electromagnetic, magnetofluidic, hydraulic, piezoelectric, pneumatic, torsional, or other mechanisms actuated by an electrical signal. Pursuant to one embodiment of the invention, a commercial electromagnetic solenoid (e.g., a Clark Synthesis TST429 Platinum Transducer) is utilized that uses magnetic coils to react the mass of a permanent magnet against the coupling mechanism. In some embodiments where the target medium 116 is, for example, the ground, transducers having a bandwidth range between at least 0.1 Hz to 1,000 Hz may be used. In other embodiments, any transducer suitable for coupling with the target medium 116 and delivering a signal with sufficient power for detection may be used.

In other embodiments, the transmit transducer 114 may be a pneumatic transducer that converts the sounding signal into air pressure, which can be used to move the coupling mechanism 115 with a force corresponding to the signal for transmission. Pursuant to another embodiment, the transmit transducer 114 can be a hydraulic transducer that converts the sounding signal into fluid pressure, which can then be used to move the coupling mechanism 115 with a force corresponding to the signal for transmission. In yet another embodiment, the transmit transducer 114 can be a piezoelectric transducer that converts the sounding signal to mechanical force, which can then be used to move the coupling mechanism 115 with the force corresponding to the signal for transmission. In yet another embodiment, the transmit transducer 114 can be a magnetofluidic transducer that converts the sounding signal into fluid pressure, which can then be coupled to the medium 116 by the coupling mechanism 115 to provide a force that corresponds to the signal for transmission.

The coupling mechanism 115 may be implemented in a number of different ways, such as embedding the transducer 114 in the target medium 116, attaching the transducer 114 to buried or exposed rock formations, buried spikes, bolts, or other penetrative coupling means, or the use of a weight to provide a coupling bias. Pursuant to one embodiment of the invention, the transducer 114 is attached to the top of a steel spike, the other end of which is driven into the target medium 116 to provide coupling via friction between the spike and the target medium 116. Where the target medium 116 is water or another liquid, coupling can occur from a ship or a towed device, or from some other device that is floating in the liquid.

Coupling of the transducer 115 to the target medium 116 results in the launching of an acoustic wave into the target medium 116. Signals returning to the surface of the target medium 116 may be comprised of surface- and subsurface-propagated acoustic signals that have undergone reflection and refraction, air-propagated signals, and environmental and system noise. Signals of interest returning to the receiver 120 consist of time-shifted versions of the transmitted DSSS signal, whereby the time shift is dependent on the reflection and refraction caused by subsurface features.

After the thus introduced acoustic wave undergoes changes during propagation through the medium 116, the signal is received by the receiver 120. As illustrated in FIG. 1, in some embodiments the receiver 120 may comprise a receive transducer 124 that is coupled to the medium 116 by a coupling mechanism 125. The receiver 120 may also include a power amplifier 123 for amplifying the received signal, a signal processing unit 122 for demodulating the received signal, and a spreading sequence generator 121 for generating a spreading sequence that is matched to the transmit sequence generated in the transmitter 110. The output from the signal processing unit 122 is the seismic sounding data, which is indicated by the reference numeral 130, and which describes the medium 116, such as the structural features thereof.

The receive transducer 124 can be any device that converts the received signal to a corresponding electrical signal. Pursuant to one embodiment of the invention, a commercially-available geophone (e.g., a GeoSpace GS-100 high-frequency geophone mounted in a GeoSpace PC-21 Land Case) may be used. The geophone may be comprised of a coil of wires suspended on a spring around a permanent magnet fixed to the housing. The housing is attached to a spike that is driven into the ground. As the ground moves in response to the seismic signals, the coil generates an electrical signal. Other transducers include piezoelectric materials, micromachined solid-state accelerometers, laser motion detectors, and other position, velocity or acceleration sensors.

The amplifier 123 may be may be configured to receive an input signal (e.g., from the receive transducer 124) and output a corresponding amplified signal sufficient for the signal processing unit 122 to produce reliable data. In some embodiments, the amplifier 123 may be any amplifier suitable to receive transmitted continuous spread spectrum signal without aliasing. In other embodiments, the amplifier 123 may be selected with characteristics suitable to receive the transmitted continuous spread spectrum signal, as well as any ambient seismic noise or other expected sources of acoustic data, without aliasing. Furthermore, the signal received from the receive transducer 124 may be filtered (e.g., low-pass filtered or other band pass filtered, etc.) to have characteristics suitable for the amplifier 123.

The signal processing unit 122 may be configured to receive the amplified received signal and demodulate the signal using the spreading sequence provided by the spreading sequence generator 121. In some embodiments, the signal processing unit 122 may be an ASIC, an FPGA, a DSP, or a general purpose microprocessor configured to execute software instructions stored in a computer readable memory. Pursuant to one embodiment of the invention, a commercially available personal computer (e.g., a Dell Latitude D620) programmed with conventional signal processing software (e.g., commercially available software such as MathWorks™ MATLAB®, PTC® Mathcad®, Halliburton ProMAX®, etc.) may be process the received signal.

In some embodiments, the received signals may be transferred to a processing computer by standard means. Pursuant to one embodiment of the invention, a commercially available data acquisition unit (e.g., an IOTech Personal DAQ 3001) may be used to transfer the received signals from the receive transducer 124 or the amplifier 123 to a personal computer via a Universal Serial Bus (USB) interface.

Processing consists of performing a mathematical cross correlation between the transmitted signal and the received signal to provide a measure of amplitude vs. time delay of return signal for an appropriate range of time delays. The spreading sequence generated by the spreading sequence generator 121 may be used to determine the transmitted signal. Pursuant to one embodiment of the present invention, both transmitted and received signals are recorded for a specified length of time, and fast Fourier transforms may be used to perform the cross correlation on the recorded data. Pursuant to other embodiments, any number of methods could be utilized to obtain the same mathematical results, all of which are familiar to those of skill in the art, and which could be implemented in software (e.g., MathWorks™ MATLAB®), firmware or hardware (e.g., ASICs, FPGAs, DSPs, discrete logic elements, etc.).

Once the time-domain data is obtained, existing processing techniques (e.g., those provided by the Halliburton ProMAX® software product) can be used to generate images, cross-sections, and to perform standard seismological characterization.

In some embodiments, the components described above may be powered by a portable power device. Pursuant to one embodiment of the invention, a commercially available power inverter (e.g., a Black and Decker PI750B 750 W power inverter) may be used in conjunction with, e.g., a standard car battery.

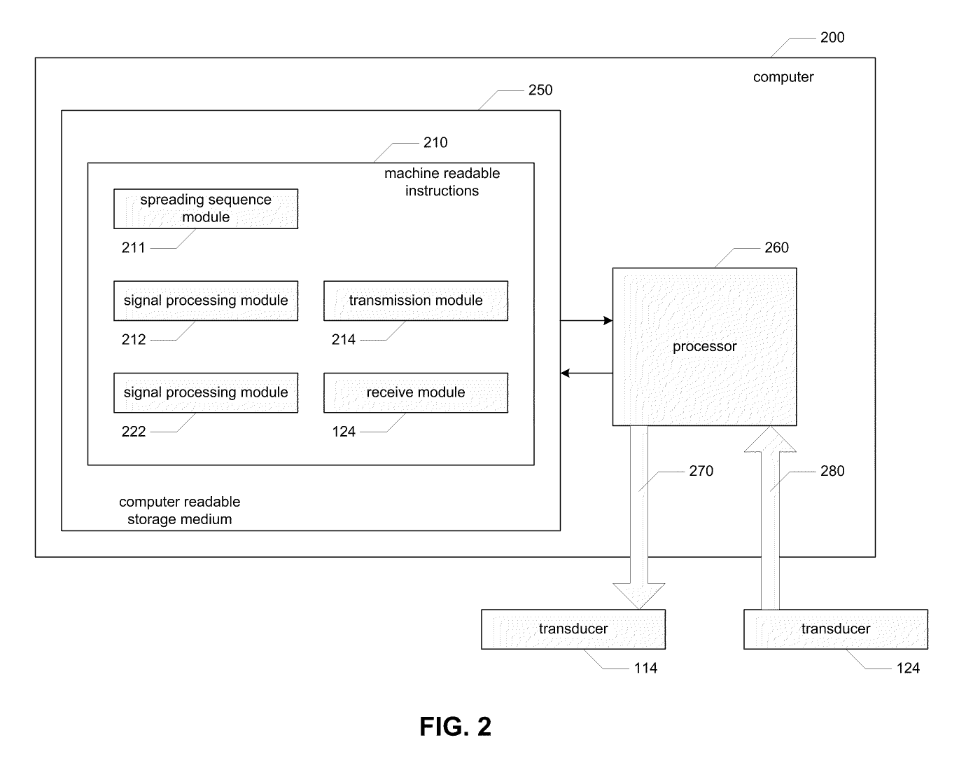

FIG. 2 illustrates a computer 200 including a computer program product for seismological sounding according to some embodiments of the present invention. As shown in FIG. 2, machine readable instructions 210 may be stored in a computer readable storage medium 250 (e.g., a random access memory (“RAM”), an electrically erasable programmable read only memory (“EEPROM”), a flash memory, an optical disk, a magnetic disk, etc.). The machine readable instructions 210 may be accessed and executable by a processor 260 to transmit data via an output component 270 (e.g., a USB interface) and receive data via an input component 280 (e.g., a USB interface). The machine readable instructions 210 may include a spreading sequence module 211 for generating the spreading sequence, a signal processing module 212 for processing the spreading sequence to generate a continuous spread spectrum signal (e.g., via DSSS modulation), and a transmission module 214 for transmitting the continuous spread spectrum signal to a transducer (e.g., via a USB interface). In some embodiments, the machine readable instructions 210 may include a receive module 224 for receiving signals from a transducer (e.g., via a USB interface), and a signal processing module 222 for processing the received signals based on the spreading sequence to generate seismic sounding data.

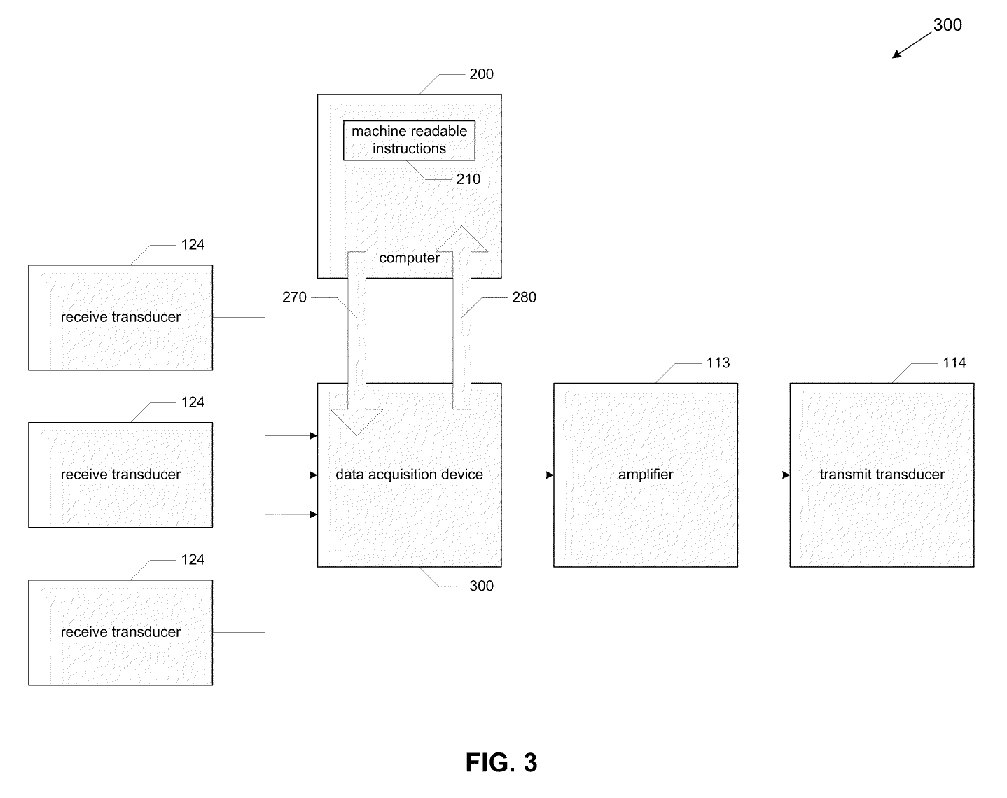

FIG. 3 illustrates a system 300 for seismological sounding including a computer 200 according to some embodiments of the present invention. As shown in FIG. 3, the computer 200 may communicate with a data acquisition device 300 via the input and output components 270, 280. The data acquisition device 300 may be configured to receive continuous spread spectrum signals from the computer 200 and transmit the continuous spread spectrum signal to the amplifier 113. The data acquisition device may be further configured to receive signals from one or more receive transducers 124 and transmit the received data to the computer 200 for signal processing. Pursuant to one embodiment of the invention, the data acquisition device 300 may be a commercially available data acquisition unit.

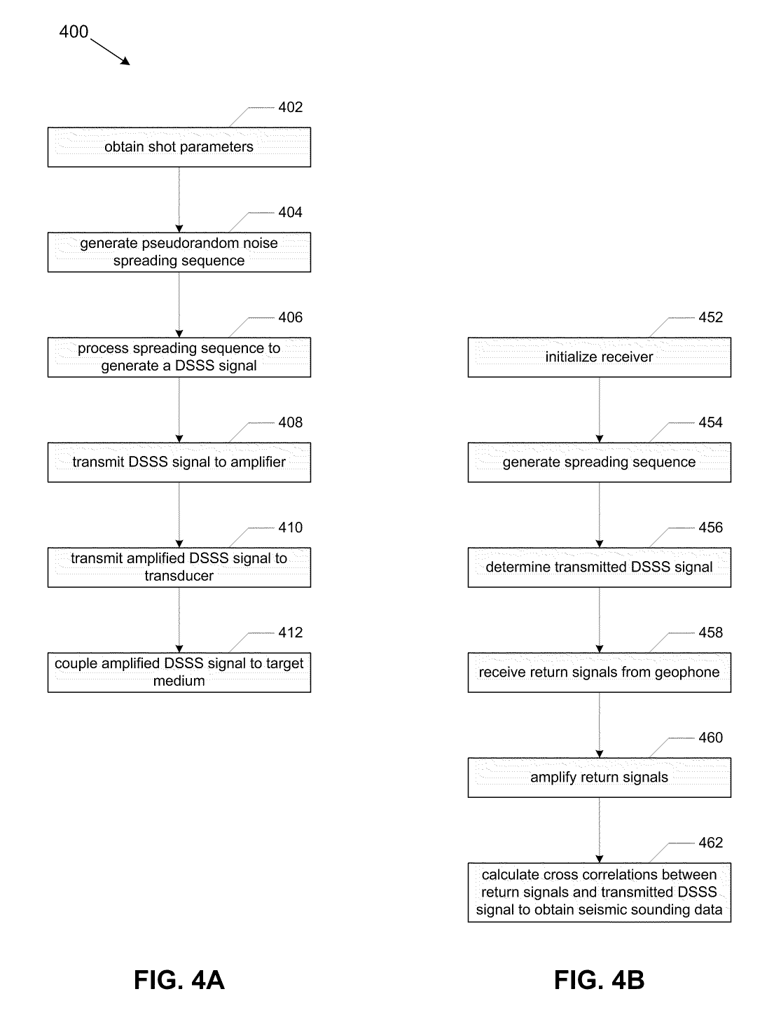

FIGS. 4A and 4B are flow charts illustrating, respectively, a process 400 for transmitting a continuous spread spectrum seismic sounding signal and a process 450 for receiving and processing return signals generated by a continuous spread spectrum sounding signal according to some embodiments of the present invention. In some embodiments, one or more of the steps in the processes 400 or 450 may be performed pursuant to software stored in a computer readable medium and one or more digital processors. In other embodiments, all or part of the processes 400 or 450 may be encoded into special purpose hardware (e.g., one or more FPGAs or application specific integrated circuits ASICs).

The process 400 for transmitting a continuous spread spectrum seismic sounding signal according to some embodiments of the present invention may begin at step 402 when the transmitter 110 receives user-specified shot parameters. The shot parameters may include a selected transmission period, selected frequency spectrum parameters, or other aspects of the transmitted signal.

At step 404, the spreading sequence generator 111 generates the spreading sequence according to spreading sequence parameters and the shot parameters.

At step 406, the signal processing unit 112 uses the spreading sequence to modulate a signal and may apply further filtering (e.g., filtering specified by the user-specified shot parameters).

At step 408, the signal processing unit 112 sends the spread spectrum signal to the amplifier 113. The amplifier 113 amplifies the spread spectrum signal as required and sends the spread spectrum signal to the transducer 114 (step 410).

At step 412, the transducer 114 transmits the spread spectrum signal, via the coupling mechanism 115, into the target medium 116.

The process 450 for receiving and processing return signals generated by a continuous spread spectrum sounding signal according to some embodiments of the present invention may begin at step 452 when the receiver 120 is initialized so that it is ready to receive, record, and process acoustic signals from the target medium 116. This may include providing adequate power to the components of the receiver 120, preparing any recording devices or software to record the received signals, and inputting into the spreading sequence generator 121 spreading sequence parameters that may be based upon the user-specified shot parameters. In some embodiments, the spreading sequence parameters input to the receiver 120 are matched to the spreading sequence parameters input to the spreading sequence generator 121, such that both of the spreading sequence generators 111, 121 will generate the same spreading sequence.

At step 454, the spreading sequence generator 121 generates a spreading sequence for the receiver 120 that corresponds to the spreading sequence generated by the spreading sequence generator 112 for the transmitter 110.

At step 456, the receiver 120 determines the continuous spread spectrum signal generated by the transmitter 110. In some embodiments, this may be performed via the signal processing unit 122.

At step 458, the receiver 120 receives the return signals input buffers of the receive transducer 124 (e.g., a geophone) and, in some embodiments, amplifies the received signal via the amplifier 123 (step 460).

At step 462, the signal processing unit 122 performs cross correlations for an appropriate range of time delays between the received signal and the transmitted signal to determine a measure of amplitude vs. time delay of return signal.

Step 462 may comprise storing the results of the cross correlation, e.g., into a computer readable medium. Step 462 may also comprise displaying the results of the cross correlation, e.g. via a computer monitor or other electronic display or a computer printout.

In some embodiments, the process 400 and the process 450 may occur concurrently. In other embodiments, some or all of steps 454, 456, and 462 may occur after the transmitter 110 has completed transmitting the continuous spread spectrum signal (i.e., after step 412 is complete) and may also occur after the receiver 120 has finished receiving return signals (i.e., after step 458 is complete).

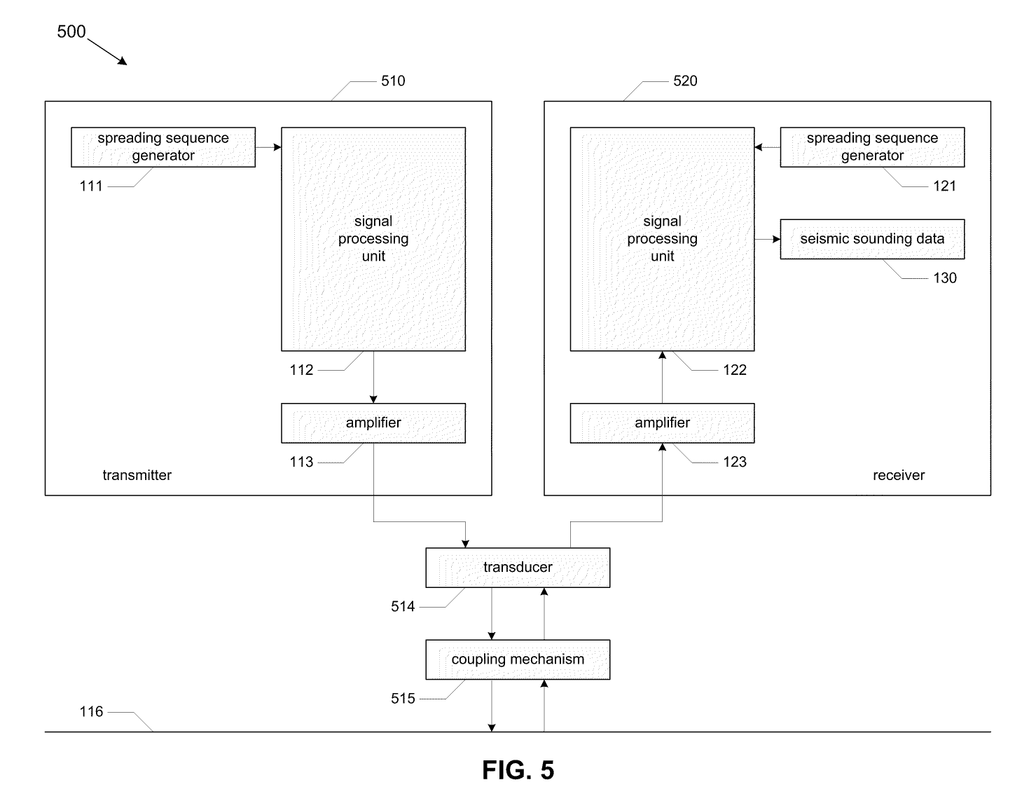

FIG. 5 illustrates a system 500 for performing seismic sounding using a spread spectrum signal. As illustrated in FIG. 5, the transmitter 510 and the receiver 520 make simultaneous use of the same transducer 514 and coupling mechanism 515. DSSS signals are amplified and applied to the shared transducer 514 in such a way as to permit signals created by the transducer 514 to be measured by the same transducer 514. Pursuant to one embodiment, a resistance impedance is used in series with an electromagnetic transducer to allow voltages induced by return signals to be measured. In some embodiments, to the transmitted signal must be selected to avoid saturating the transducer 514 with the transmit signal, and the amplifier 123 of the receiver 520 must have wide enough dynamic range to measure the small-amplitude return signal summed with the large-amplitude transmit signal.

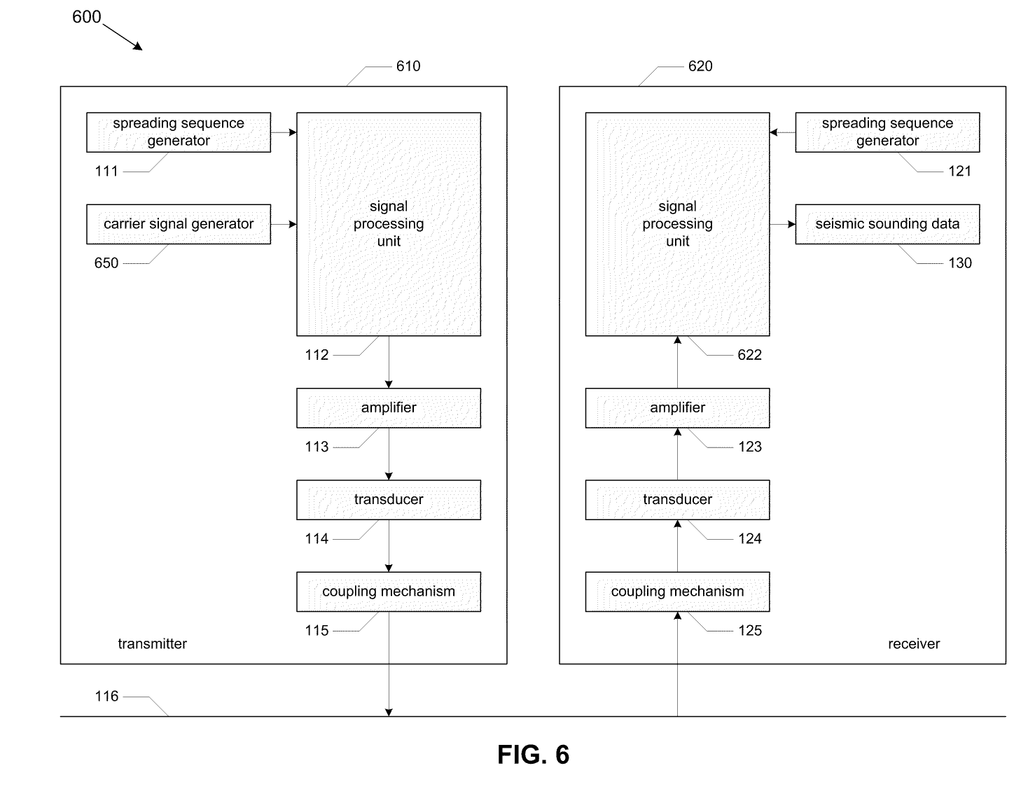

FIG. 6 illustrates a system 600 for performing seismic sounding using a spread spectrum signal. As illustrated in FIG. 6, the transmitter 610 employs a carrier signal. A carrier frequency is generated at the carrier signal generator 650 and modulates the spreading signal. Signal processing at the unit 622 in the receiver 620 recovers the carrier and uses it to demodulate the sounding data.

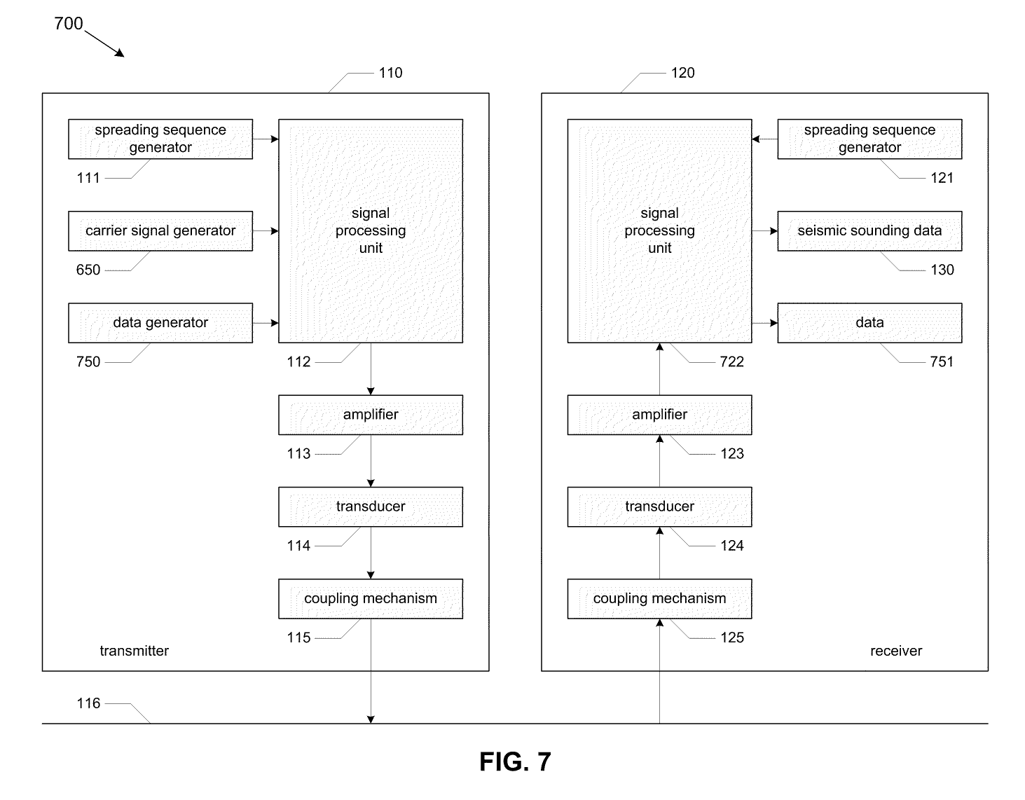

FIG. 7 illustrates a system 700 for performing seismic sounding using a spread spectrum signal. As illustrated in FIG. 7, data can be transmitted along with the sounding signals and can be recovered at the receiver 720. A data signal generated by a data signal generator 750 can modulate the spreading signal or optional carrier signal of the transmitter 710. The signal processing unit 722 in the receiver 720 can recover the data 751 as separate from sounding data.

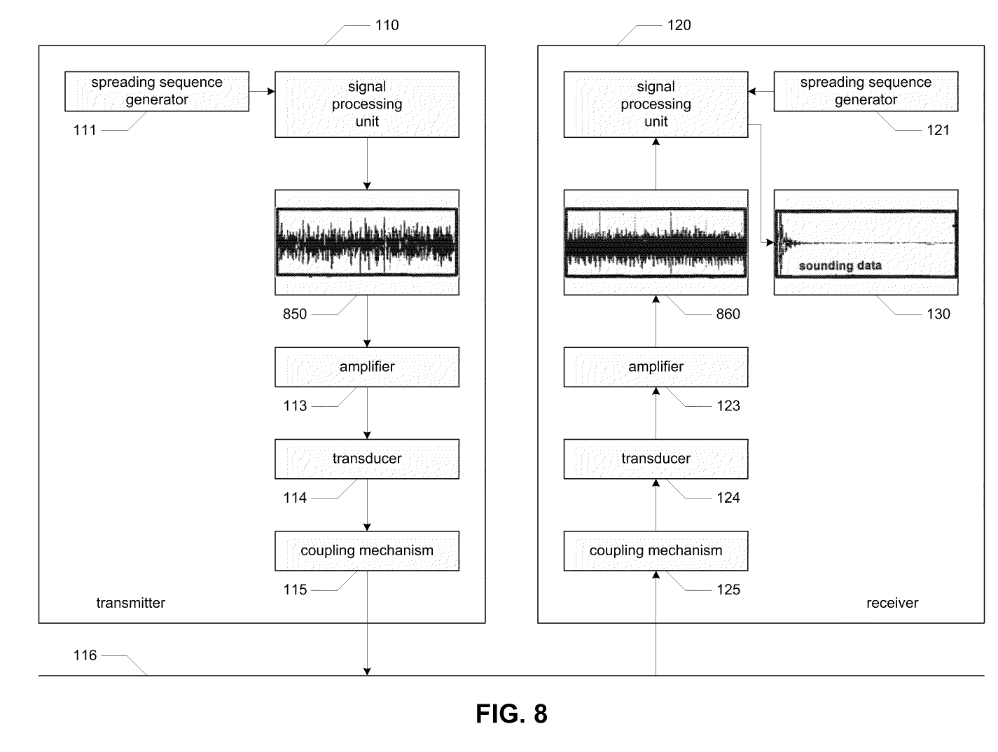

FIG. 8 illustrates an exemplary transmitted continuous spread spectrum signal 850 in the transmitter 110, and an exemplary return signal 860 in the receiver 120 The return signal may be composed of a plurality of different time-shifted copies of the transmitted continuous spread spectrum signal superimposed on each other. Also illustrated in FIG. 8 is an example of the seismic sounding data 130 after the signal processing unit 122 has performed the cross correlations described above to calculate the amplitude vs. time delay of return signal for an appropriate range of time delays.

In some embodiments of the invention, a plurality of receivers (e.g., receivers 120, 320, 420, or 520) can be utilized to receive transmissions from a single transmitter (e.g., a transmitter 110, 310, 410, or 510). Each receiver uses the spreading sequence matched to that of the transmitter to provide the sounding data for each transmitter receiver pair.

Pursuant to yet another embodiment of the invention, a plurality of transmitters (e.g., transmitters 110, 310, 410, or 510) and a plurality of receivers (e.g., receivers 120, 320, 420, or 520) can be utilized. Each transmitter is assigned a different spreading sequence. The spreading sequences are selected to have low cross correlation, and therefore to provide low interference between the transmitted signals. The transmitters can transmit simultaneously, in which case each receiver receives the sum of sounding signals from all active transmitters. Each demodulator of the receivers uses the spreading sequence matched to each transmitter to provide the sounding data for each transmitter receiver pair. By using multiple transmitters simultaneously, faster soundings, faster holographic imaging, and faster simultaneous soundings over a wide area may be provided.

Pursuant to another embodiment of the invention, transmission and reception are used over a period of time to provide extended sounding data. A DSSS Signal is transmitted from one or more transmitters over an extended period of time. Pursuant to some embodiments of the present invention, transmissions may continue for 10 minutes or more. One or more receivers receive the DSSS signal and synchronization of the spreading code, so-called “acquisition”, is achieved. After acquisition, extended sounding data is recovered for each transmitter receiver pair. The longer the transmitting duration, the more total energy is transmitted into the target medium 116, and the more total energy is returned to the receiver. Embodiments according to this aspect of the invention therefore allow for the transmission of a smaller amount of energy per unit of time, while allowing an equivalent amount of total energy to be applied to features of interest. Extended duration sounding may be useful for dynamic environments (e.g., to track the progress of tunnel-boring machines). Furthermore, extended duration sounding may be used to image fault movement, potentially even during an earthquake.

### Example

An embodiment of the above described seismic sounding systems and methods was used to perform a seismic survey at the South Juanita Mine adit in the Magdalena Mountains. The embodiment used to perform the seismic survey described comprised an AudiSource Amp5.3 amplifier coupled to a Clark Synthesis TST429 Platinum transducer, GeoSpace GS-100 geophones, an IOTech Personal DAQ 3001, and a Dell Latitude D620 laptop computer. The transmitter is a commercially available amplifier and a low-power audio transducer, and the receiver is a commercial single-axis geophone. The transmitter and laptop were powered by a Black and Decker PI750AB power inverter plugged into the field vehicle. The transmitter was coupled to the ground via a small steel stake hand driven with a hammer, and the single geophone was moved to measured offsets.

The following computer code, which is written in C++, can be used to control I/O and to perform signal processing, as described above, with regard to performing a sounding using multiple transmitters 110 and multiple receivers 120:

#include <stdio.h>
#include <AcquisitionBoard.h>
class CTransducer
{
public:

CCoordinate m_cLocation;
CBuffer m_aData;

};
void main(void)
{

| | |
|---|---|
| double | Power, Duration, SampleRate; |
| short unsigned | NumberOfTransmitters, |

NumberOfReceivers;

// read parameters for this data collection sequence
ReadParameters(Power, Duration, SampleRate,

NumberOfTransmitters, NumberOfReceivers);

| // create structures to hold transducer information and data | |
|---|---|
| CTransducer aTransmitters | = new CTransducer[NumberOfTransmitters]; |
| CTransducer aReceivers | = new CTransducer[NumberOfReceivers]; |

// create a structure to hold crosscorrelations for all transducer pairs
CBuffer mCorrelations =

new CBuffer[NumberOfTransmitters * NumberOfReceivers];

// read information about transducers
ReadTransmitterInformation(aTransmitters);
ReadReceiverInformation(aReceivers);
// initialize acquisition board
InitializeAcquisitionBoard(Power, Duration, SampleRate,

NumberOfTransmitters, NumberOfReceivers);

// create Gold cold PRN sequences in output buffers
// each transmitter is given a different sequence to transmit
CreateGoldCodes(aTransmitters);
// give the acquisition board control over transmit and receive buffers
GiveBuffersToAcquisitionBoard(aTransmitters, aReceivers);
// transmit and receive data
// all transmitters will transmit their buffers simultaneously
// all receiver inputs will be recorded into their buffers
TransmitAndReceive( );
// data collection is now complete
// compute crosscorrelation for all pairs
for(int iTransmitter = 0;

```
  iTransmitter < NumberOfTransmitters;
  iTransmitter++)
```

{

for(int iReceiver = 0;

```
  iReceiver < NumberOfReceivers;
  iReceiver++)
```

{

ComputeCrossCorrelation(

aTransmitter[iTransmitter],
aReceiver[iReceiver],
mCorrelations[iTransmitter + iReceiver * NumberOfTransmitters]);

}

}
// store to disk for further processing by third-party software
WriteDataToDisk(mCorrelations);
// clean up
delete [ ] aTransmitters;
delete [ ] aReceivers;
delete [ ] mCorrelations;
// de-initialize board
DeInitializeAcquisitionBoard( );
// done

}

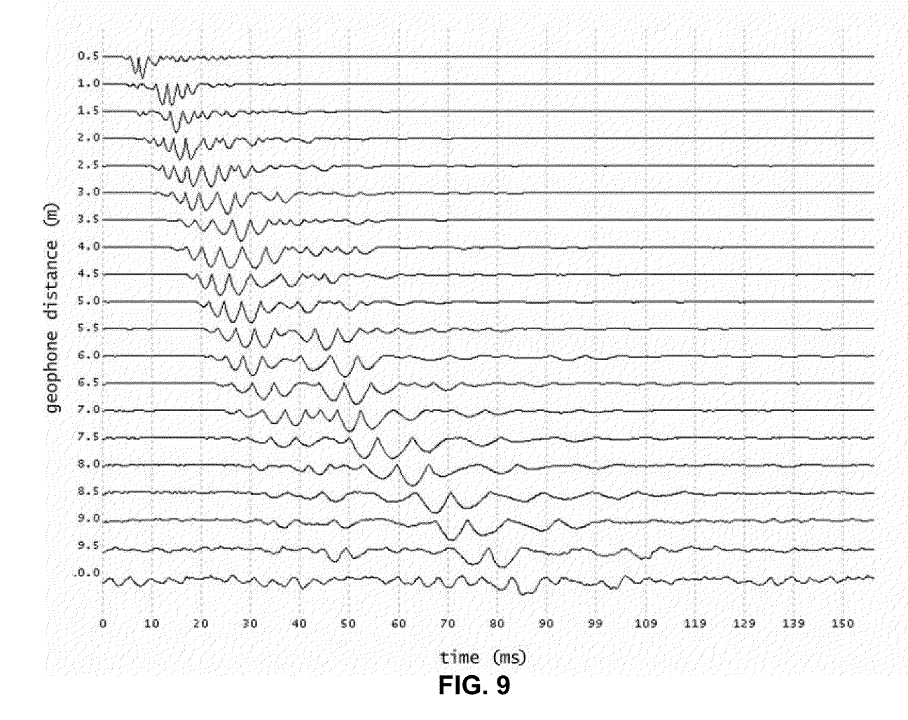

FIG. 9 shows a field record of the processed signals made using a 200 Hz bandwidth and a 20-second integration. The transmitter and geophone spanned the adit on a perpendicular line, and the 1 meter-wide by 1.5 meter-tall adit was estimated to be 10 m below the surface at this point. The results display expected seismic signals.

The following computer code, which is written in C++, can be used to control I/O and to perform signal processing, as described above, according to an embodiment wherein transmission and reception are used over a period of time to provide extended sounding data. In some embodiments, the FillTransmitBuffers( ) subroutine may be used to generate additional portions of the PRN sequence, and the ReceiveBuffersFull( ) subroutine may be used to periodically perform the cross-correlation between received signals and the transmitted signals:

#include <stdio.h>
#include <AcquisitionBoard.h>
class CTransducer
{
public:

CCoordinate m_cLocation;
CBuffer m_aData;

};

| | |
|---|---|
| CTransducer[ ] | aTransmitters; |
| CTransducer[ ] | aReceivers; |
| CBuffer[ ] | mCorrelations; |
| double[ ] | aSeeds; |
| int | NumberOfTransmitters, NumberOfReceivers; |

void main(void)
{

| double Power, Duration, SampleRate; | |
|---|---|
| // read parameters for this data collection sequence | |
| ReadParameters(Power, Duration, SampleRate, NumberOfTransmitters, | |
| | NumberOfReceivers); |
| // create structures to hold transducer information and data | |
| aTransmitters | = new CTransducer[NumberOfTransmitters]; |
| aReceivers | = new CTransducer[NumberOfReceivers]; |
| // create a structure to hold crosscorrelations for all transducer pairs | |
| mCorrelations | = new CBuffer[NumberOfTransmitters * NumberOfReceivers]; |
| // create a buffer to hold a PRN seed for every transmitter | |
| aSeeds | = new double[NumberOfTransmitters]; |

// read information about transducers
ReadTransmitterInformation(aTransmitters);
ReadReceiverInformation(aReceivers);
// initialize acquisition board
InitializeAcquisitionBoard(Power, Duration, SampleRate,

NumberOfTransmitters,
NumberOfReceivers);

// tell I/O board how to ask for more transmit data
RegisterFillTransmitBuffers(FillTransmitBuffers);
RegisterReceiveBufferCallback(ReceiveBuffersFull);
// give the acquisition board control over transmit and receive buffers
GiveBuffersToAcquisitionBoard(aTransmitters, aReceivers);
// create initial seed for each transmitter
// seeds are chosen to create a different sequence for each transmitter,
// and so that each transmitter sequence's autocorrelation with
// every other is very low. one could also use different sequence
// generators for each transmitter
InitializeSeeds(aSeeds);
// tell the board to begin transmitting from the transmit
// buffers and reading inputs into the receive buffers
// the board will call back to obtain more transmit data,
// and will call back when the receiver data is full
StartTransmitAndReceive( );
// do nothing until time to stop
//
// callbacks below will be used to flow data
// into and out of the acquisition board
//
// user interface can be updated here, etc.
WaitForStopSignal( );
// tell the board to stop
StopTransmitAndReceive( );
// clean up
delete [ ] aTransmitters;
delete [ ] aReceivers;
delete [ ] mCorrelations;
delete [ ] aSeeds;
// de-initialize board
DeInitializeAcquisitionBoard( );
// done

}
void FillTransmitBuffers(void)
{

// for each transmit buffer, use its current seed to
// continue to generate the PRN sequence assigned to it
for(int i = 0; i < NumberOfTransmitters; i++)
{

// fill the buffer with the new section
// of its sequence
//
// leave the seed updated so the next
// call continues the sequence
FillTransmitBuffer(aTransmitters[i], aSeeds[i]);

}

}
void ReceiveBuffersFull(void)
{

// compute crosscorrelation for all pairs
for(int iTransmitter = 0;

```
  iTransmitter < NumberOfTransmitters;
  iTransmitter++)
```

{

for(int iReceiver = 0;

```
  iReceiver < NumberOfReceivers;
  iReceiver++)
```

{

ComputeCrossCorrelation(

aTransmitters[iTransmitter],
aReceivers[iReceiver],
mCorrelations[iTransmitter + iReceiver * NumberOfTransmitters]);

}

}
// store to disk for further processing
WriteDataToDisk(mCorrelations);
// during continuous sounding, other software can monitor
// for triggers, perform periodic postprocessing,
// archive data, or remove uninteresting data

}

Although the term “ground” has been used above to identify the medium in which the acoustic wave is propagated, the medium can actually be any medium through which an acoustic signal can be transmitted. By way of example only, in addition to the ground, the medium can also be other solids such as rocks, buildings, other structures, concrete, metal, and wood, as well as water and other liquids. It is to be understood that the medium can also contain air or gas pockets.

While various embodiments of the present invention have been described above, it should be understood that they have been presented by way of example only, and not limitation. Thus, the breadth and scope of the present invention should not be limited by any of the above described exemplary embodiments. Moreover, any combination of the above-described elements in all possible variations thereof is encompassed by the invention unless otherwise indicated herein or otherwise clearly contradicted by context.

1. A method of seismological sounding, including the steps of:
generating a continuous spread spectrum signal;
generating in a target medium an acoustic wave corresponding to the spread spectrum signal;
receiving one or more return signals from the target medium generated by interaction between said acoustic wave and the target medium; and
processing the return signals to obtain seismic sounding data describing the target medium.

2. A method according to claim 1, wherein said step of generating a continuous spread spectrum signal comprises generating a pseudorandom bit sequence.

3. A method according to claim 2, wherein said step of generating a continuous spread spectrum signal further comprises using said pseudorandom bit sequence to create a direct-sequence spread spectrum (“DSSS”) signal.

4. A method according to claim 2, wherein said step of generating a continuous spread spectrum signal further comprises processing the pseudorandom bit sequence by at least one of bandwidth limiting and linear modulation.

5. A method according to claim 1, wherein said step of generating an acoustic wave corresponding to the spread spectrum signal comprises generating the acoustic wave for a period of time.

6. A method according to claim 1, wherein said step of generating an acoustic wave comprises:
converting the signal into at least one of mechanical motion, air pressure, or fluid pressure, and
transmitting the converted signal into the target medium.

7. A method according to claim 1, wherein generating an acoustic wave comprises at least one of embedding a transducer in the target medium and attaching a transducer to as object that is at least partially embedded in the target medium.

8. A method according to claim 7, wherein said step of receiving one or more return signals comprises utilizing said transducer to receive said return signals.

9. A method according to claim 8, wherein said step of processing the return signals comprises utilizing said transducer to convert said return signals to electrical signals.

10. A method according to claim 1, wherein the step of processing the return signals comprises demodulating the return signals based upon the continuous spread spectrum signal.

11. A method according to claim 1, which includes the further step of amplifying at least one of said continuous spread spectrum signal and said return signals.

12. A method according to claim 1, wherein the step of receiving one or more return signals comprises receiving one or more return signals for a period of time.

13. A method according to claim 1, wherein
the step of generating a continuous spread spectrum signal further comprises generating a plurality of continuous spread spectrum signals, and
the step of generating an acoustic wave corresponding to the spread spectrum signal further comprises simultaneously generating a plurality of acoustic waves at different sites, each acoustic wave based on one of the plurality of continuous spread spectrum signals.

14. A system for effecting seismological sounding in a medium, comprising:
a spreading sequence generator configured to generate a continuous spread spectrum signal;
a transmit transducer configured to receive the continuous spread spectrum signal, mechanically couple the continuous spread spectrum signal to a target medium, and generate in the target medium an acoustic wave corresponding to the spread spectrum signal;
a receive transducer configured to receive one or more acoustic return signals from the target medium generated by interaction between said acoustic wave and the target medium and convert the acoustic return signals to electronic return signals; and
a signal processor configured to receive the electronic return signals and process the electronic return signals to obtain seismic sounding data describing the medium.

15. A system according to claim 14, wherein said spreading sequence generator is configured to generate a direct-sequence spread spectrum (“DSSS”) signal.

16. A system according to claim 14, wherein said transmit transducer is configured to mechanically couple the continuous spread spectrum signal to the target medium using at least one of mechanical motion, air pressure, and fluid pressure.

17. A system according to claim 16, further comprising a coupling mechanism configured to transmit the air pressure or fluid pressure to the target medium.

18. A system according to claim 17, wherein said coupling mechanism comprises an object at least partially embedded in the target medium.

19. A system according to claim 14, wherein said transmit transducer and said receive transducer are the same transducer.

20. A system according to claim 14, which further includes an electronic amplifier configured to amplify at least one of said spread spectrum signal and said return signals.

21. A computer program product for seismological sounding, said computer program product comprising a digital storage media and a set of machine readable instructions stored on said digital storage media, wherein said instructions are executable by a computer to:
generate a continuous spread spectrum signal;
transmit the continuous spread spectrum signal to a transmit transducer mechanically coupled to a target medium;
receive one or more return signals from a receive transducer mechanically coupled to a target medium; and
process the return signals to obtain seismic sounding data describing the target medium.

22. A computer program product according to claim 21, wherein generating a continuous spread spectrum signal comprises generating a pseudorandom bit sequence.

23. A computer program product according to claim 22, wherein generating a continuous spread spectrum signal further comprises using said pseudorandom bit sequence to create a direct-sequence spread spectrum (“DSSS”) signal.

24. A computer program product according to claim 22, wherein generating a continuous spread spectrum signal further comprises processing the pseudorandom bit sequence by at least one of bandwidth limiting and linear modulation.

25. A computer program product according to claim 21, wherein transmitting the continuous spread spectrum signal to a transmit transducer comprises transmitting the continuous spread spectrum signal for a period of time.

26. A computer program product according to claim 21, wherein said transmit transducer and said receive transducer are a single transducer.

27. A computer program product according to claim 21, wherein processing the return signals comprises demodulating the return signals based upon the generated continuous spread spectrum signal.

28. A computer program product according to claim 21, wherein said machine readable instructions further include instructions executable by a computer to amplify at least one of said continuous spread spectrum signal and the return signals.

29. A computer program product according to claim 21, wherein receiving one or more return signals comprises receiving one or more return signals for a period of time.

30. A computer program product according to claim 21, wherein:
receiving one or more return signals comprises receiving one or more multiplexed return signals comprising return signals generated by interaction between said a plurality of continuous spread spectrum signals and the target medium; and
processing the return signals comprises demultiplexing the multiplexed return signals based upon the plurality of continuous spread spectrum signals.
